(19) United States
(12) Patent Application Publication
(10) Pub. No.: US 2010/0139256 A1
(43) Pub. Date: Jun. 10, 2010

(54) METHOD FOR REPLACING CATALYSTS AND PARTICULATE FILTERS

(76) Inventor: Bartolomeo DeCarolis, Fasano (BR) (IT)

Correspondence Address: Robert Ruschena;R. Ruschena Patent Agent, LLC, 8400 E. Crescent Parkway, Suite 600, Greenwood Village, CO, 80111, US

(21) Appl. No.: 12/452,470

(22) PCT Filed: Sep. 17, 2007
(86) PCT No.: PCT/IT2007/000643

§ 371 Date: Jan. 2, 2010

(30) Foreign Application Priority Data
Jul. 9, 2007 (IT) TO2007A000497

(51) Int. Cl. F01N 3/023; F01N 3/10; F01N 3/035; B23P 6/00

(52) U.S. Cl. 60/295; 60/299; 60/297; 29/402.01

(57) ABSTRACT

Method of replacing catalysts, particulate filters, retrofit of such components and similar,’ in all of their variants, which foresees a step of removing the spent catalyst (1, 2) from the exhaust manifold (3), a step of cleaning the space (4) and inserting the new component and a step of restoring the manifold portion.

The object of the present finding is a regeneration process for catalysts and particulate filters, i.e. for devices installed on automobiles, industrial vehicles, and more generally on all means equipped with an internal combustion engine, which allow reduction of exhaust gases that are harmful to the environment and to human health, known as catalysts and particulate filters.

As known, the exhaust system of automobiles is mainly made up of three elements: a front part made up of a cast iron exhaust manifold, catalyst, hose and particulate filter, where these devices can be joined to form a single piece or else connected together with suitable fitting flanges, a central part and a rear part both consisting of tubes and mufflers according to the type of vehicle. Automotive manufacturers from the beginning equip each vehicle with its own catalyst and, in the case of modern Diesel engines, also with a particulate filter. Technically the catalyst is classified as a chemical reactor since inside of it multiple chemical reactions take place between the exhaust gases and the precious metals contained in it in order to limit the harmful emissions. On the inside, the catalyst can have both a ceramic structure furrowed by a plurality of small channels, with the characteristic “honeycomb” shape, and a structure made up of metallic sheets assembled with better known techniques.

For vehicles meeting the “Euro 4” standard, positioned after the catalyst there is normally also a particulate filter, a device capable of reducing particle emissions in diesel engines. On the outside it is like a catalyst—or rather in some models it is contained in the same structure as the catalyst downstream thereof and a distance of a few centimetres from it—and consists of a silicon carbide filtering support made up of very thin porous channels closed at one end: the exhaust gases manage to cross the pores whereas the particulate is held by them. When the dust accumulates, the filter is regenerated by burning the particulate. For this reason the temperature of the filter is taken to 400°-600° C., activating a post-injection of fuel that sends unburnt Diesel fuel into the filter that burns there raising the temperature. The particulate filter can work according to two distinct ways: using an additive that is automatically mixed with the Diesel fuel at each refill to lower the temperature at which the regeneration is activated, or else without additive but having the surface of its small channels impregnated with noble metals with the function of catalysts.

Moreover, for vehicles not provided with a particulate filter there are retrofits available that act as an additional filter, with the outer structure similar to a catalyst. It should be remembered that currently vehicles can be equipped from the outset with two or more catalysts to which the particulate filter is added.

This such varied situation brings great difficulties in the management of a spare parts warehouse. It is difficult if not impossible to have pieces readily available since many items are not yet produced as spare parts even though there is already a great demand. Currently, when there is a problem with the front part of the exhaust system, the piece can be replaced with an genuine spare part or with a part from the parallel market paying a substantial cost, or else just the defective catalytic block can be replaced with a universal model (consisting of a monolith enclosed by a metallic structure with tubes to be welded to the ends), supplied by numerous manufacturers. This universal catalyst should have the same anti-pollution characteristics as the original one. However, it is not always possible to obtain a quality product, but rather one can fall foul of products that have a catalytic power that is only efficient for a few kilometres, due to the small amount of precious metals used. This modification is more suited to older-generation catalysts, with simple assembly characteristics, and it is a job that can mainly be carried out by a tradesman with the means available for carrying out precise measurements. In addition, the costs are not always low.

By regeneration, we also mean the replacement of just the inner monolith of an original piece through perpendicular cutting of the converter with respect to its axis, and in any case at just one point. The inside is then broken, emptied and cleaned and all of this for all models. Breaking up the monolith increases the dispersion of the dust held by it into the workspace which, moreover, makes a lot of units unsuitable for disposal and consequent recovery of leftover precious metals. It should be specified that the firms that take care of the recovery of spent catalysts prefer whole pieces rather than broken ones so that the metal recovery process is simpler and more complete. A structure made up of two rolled up sheets, one smooth and the other corrugated, impregnated with precious metals, without any so-called small frame, is inserted on the inside. As regards the particulate filters, the genuine spare part is chosen; the spare part, however, is not yet widely available and, moreover, the costs are relatively high.

The main purpose of the present invention is to speed up the time needed to process and deliver the item, at the same time substantially reducing costs and making people more environmentally-friendly: we estimate that regenerating a unit requires only 10% of the energy taken to product a corresponding new unit. In order for any used component to be considered to have been regenerated it has to have been put back as it was when new through an industrial process that respects the most recent technological model, the resulting product having to be totally equivalent to the new one and ensuring performance in accordance with the initial operating specifications. The process in object offers the possibility of replacing the inner part of the catalyst with a new structure by removing the spent, clogged and broken monolith from the top part, without making any modification to the general construction of the piece, as expressed in claim 1.

The advantages that can be obtained by applying this technique can be summed up as follows: the block to be replaced is removed whole, without releasing dust into the environment and without harming the health of the worker who will perform the operation. Not modifying the overall structure, the resulting product shall consequently be the same as the original. Moreover, in most cases the original outer structure is kept, which is of excellent workmanship. One may choose to improve the original specifications, still respecting the current standards, by inserting a product that ensures better performance and at the same time contributes to the reduction of consumption. Finally, a high quality/price ratio of the end product is obtained.

These and other advantages shall become clearer from the following detailed description of some preferred but not limiting example embodiments, with reference to the drawings in which:

FIGS. 1-5 represent the sequence of the steps of a first embodiment of the process according to the invention;

FIGS. 6-10 show the same sequence of steps of a second embodiment of the process;

FIGS. 11-14 illustrate a third embodiment of the process;

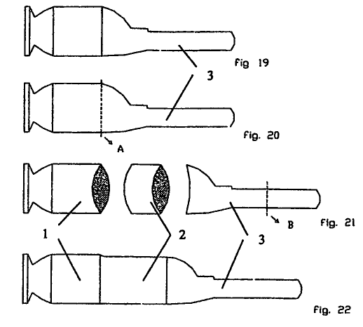

FIG. 15 shows the case in which on the outside there is a single body and on the inside there is a catalyst and a particulate filter;

FIGS. 16-18 illustrate the application of the process in the case of particulate filters with a single and independent structure;

FIGS. 19-22 illustrate the application of the process in the case of addition of a particulate filter to the initial catalytic structure.

With reference to the aforementioned figures, the process in question is therefore a regeneration method for catalysts, particulate filters and similar, in all their variants that foresees a step of removing the spent catalyst (1, 2) from the exhaust manifold (3), a step of cleaning the space (4) and inserting the new component and a step of restoring the manifold portion. In greater detail, the process comprises different embodiments, which can be applied to all models of catalyst, particulate filters and retrofits in general.

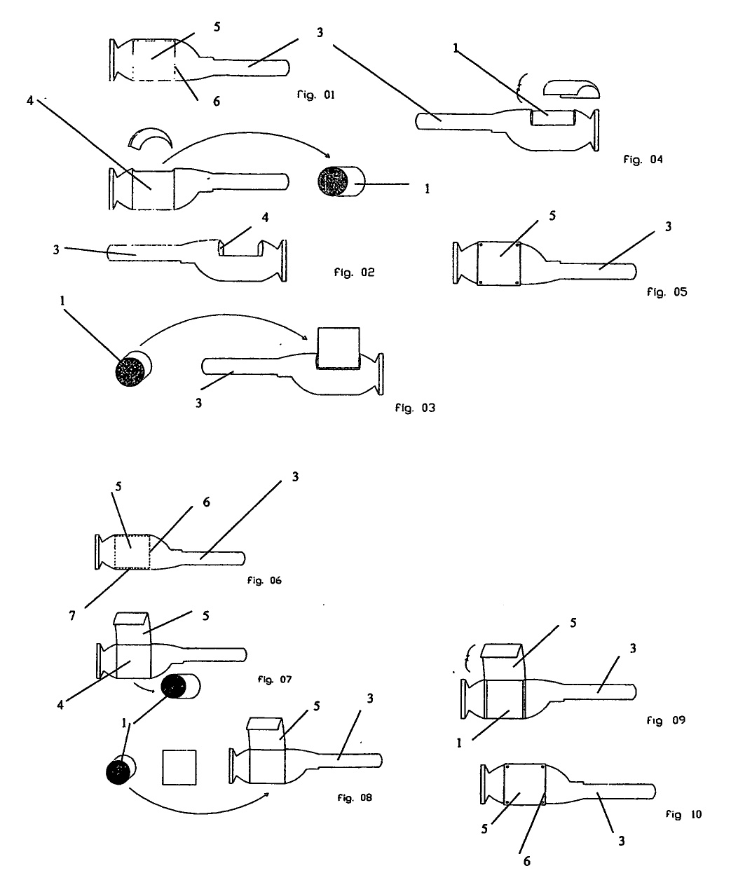

According to a first embodiment the process consists of:
1—Sectioning in half the sheet (5) that encloses the catalytic body (FIG. 1) taking care to make the cut (6) outside of the original welds, otherwise they will be a hindrance to the removal of the catalytic block. Once this operation has been carried out, we have a structure with removable cover.
2—Removing the catalytic body that is worn out, clogged or in any case in need of replacement, from the top part (FIG. 2). This operation is simple and has the advantage of not releasing dust into the environment, protecting the worker performing this operation.
3—Cleaning the inside and outside from all processing residue using a sandblaster.
4—Selecting the most suitable support to insert inside (FIG. 3). By support, we mean a body formed from a steel casing, known as “small frame”, containing the actual catalytic structure. The size can vary from model to model, and moreover it can be round, oval, trapezoidal or any other shape. A metallic catalytic support can be used, having a steel structure inside of it, or else a ceramic catalytic support can be used, which requires the use of some elastic protections in metal mesh.
5—Welding the outer part of the support with the casing of the catalyst, so as to avoid vibrations at the intake of the exhaust gases (FIG. 4).
6—Covering it back up with the cover that was removed earlier, taking care that it is lined up precisely (FIG. 4).
7—Welding in the same parts (6) where the cuts had been made previously with a TIG/MIG type welder or else wire welder.
8—To avoid vibrations due to back pressure, making some holes according to requirements on the top and bottom part of the catalytic body, precisely enough to perforate just the outer part.
9—Proceeding with a welding spot between the plate of the new support and the outer part of the catalyst so as to create a single block (FIG. 5).
10—Possibly painting at a high temperature.

A second embodiment of the regeneration process foresees the following variants:
1—Making two cuts (6), one on the right and one on the left of the initial processing welds taking care not to completely section the piece, but making cuts up to half way round its circumference (FIG. 6)
2—Proceeding by cutting, with the tool considered most suitable, perpendicularly from one cut (7) to the other so as to obtain a hatch. As a result of this there will be a structure sectioned in half with the top part able to be opened with simple pliers (FIG. 7).
3—Proceeding like in the first embodiment, points 2-5 (FIG. 8).
4—Lowering the cover, lining the whole thing up and welding (tig/mig/wire) at the points where the cuts had been made (FIG. 9).
5—Proceeding like in the first embodiment, points 8-10 (FIG. 10).

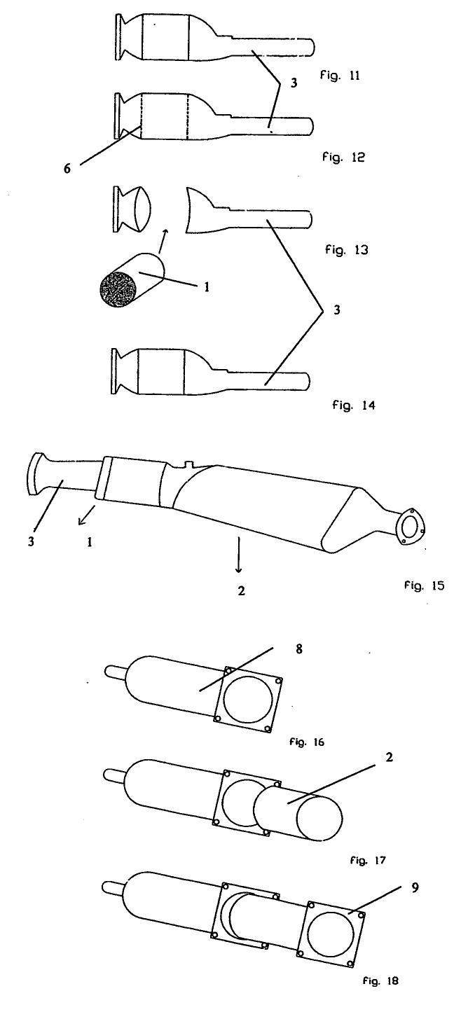

A third embodiment, on the other hand, foresees the following variants:
1—Completely sectioning the catalytic body, taking care to cut outside of the original welds (FIGS. 11-12).
2—Calculating the size of the outer catalytic body and selecting the most suitable new support, with reference to the size (FIG. 13).
3—Welding the new support, containing the catalytic structure, to the original part (FIG. 14).
4—Possibly applying high temperature paint.

In the case (FIG. 15) in which on the outside there is a single body and on the inside there is a catalyst and a particulate filter (2) one can proceed as considered most suitable with reference to the embodiments described above. One proceeds in a similar way in the case of retrofit (catalyst and particulate filter) proposed by the spares market for vehicles without an original particulate filter.

The same process is again used, according to one of its variants, in the case of particulate filters with a single and independent structure (8) (FIG. 16), by removing the spent block and inserting the new particulate filter (FIG. 17). Alternatively, taking care to keep the structure of the particulate filter whole and reassembled, when empty, one can proceed by welding, at the end of the support, a flange (9) of the same size as the original one of the particulate filter (FIG. 18). In this case it will not be necessary to make welds or modifications either for the first regeneration operation, or for the subsequent ones and, moreover, there shall be no variations in bulk at assembly.

Finally, the process also allows a particulate filter to be added to the initial catalytic structure (FIG. 19). One proceeds in this way:
1—Sectioning at point A (FIG. 20).
2—Inserting a particulate filter (stainless steel outer structure) with the same outer diameter of the catalyst.
3—Reassembling the whole thing through welding.
4—The result will be a structure the length of which exceeds the original length: to resize the piece, a cut can be made at point B (FIG. 21), one will have a piece formed from catalyst and particulate filter able to be installed in the same way as the main piece.
5—Possible sandblasting (FIG. 22).

1. Regeneration process far catalysts and particulate filters, retrofits of such components and similar, in all their variants comprising:
removal steps of the spent catalyst (1, 2) from the exhaust manifold (3),
a step of cleaning the space (4);
steps of inserting the new component and restoring the manifold portion;
and an optional procedure to add a particulate filter to the initial catalyst structure.

2. Process according to claim 1 wherein, according to a first embodiment, the removal steps of the spent catalyst from the exhaust manifolds comprise:
sectioning in half the sheet (5) that encloses the catalytic body;
removing the catalytic body from the top part.

3. Process according to claim 1 wherein, according to a first embodiment, the steps of inserting the new component and restoring the manifold portion comprise:
selecting the most suitable support to insert inside;
welding the outer part of the support with the casing of the catalyst;
covering it back up with the cover removed earlier;
welding the same parts (6) where the cuts had been made earlier;—making holes according to requirements on the top and bottom part of the catalytic body;
proceeding with a welding spot between the plate of the new support and the outer part of the catalyst;
painting at high temperature.

4. Process according to claim 1, wherein according to a second embodiment, the removal steps of the spent catalyst from the exhaust manifolds comprise:
making two cuts (6), one on the right and one on the left of the initial processing welds up to halfway round its circumference;
proceeding by cutting perpendicularly from one cut (7) to the other so as to obtain a hatch;
removing the catalytic body from the top part.

5. Process according to claim 1 wherein, according to a second embodiment, the steps of inserting the new component and restoring the manifold portion comprise:
selecting the most suitable support to insert inside;
welding the outer part of the support with the casing of the catalyst;
lowering the cover;
lining the whole assembly up and welding in the points at which the cuts had been made;
making some holes according to requirements on the top and bottom part of the catalytic body;
proceeding with a welding spot between the plate of the new support and the outer part of the catalyst;
painting at high temperature.

6. Process according to claim 1, wherein, according to a third embodiment, the removal step of the spent catalyst from the exhaust manifolds consists of completely sectioning the catalytic body;
said process is applied to the cases when:
on the outside there is a single body and on the inside there is a catalyst (1) and a particulate filter (2); or there is a need for
retrofitting the catalyst and the particulate filter on vehicles without the original particulate filter.

7. Process according to claim 1 wherein, according to a third embodiment, the steps of inserting the new component and restoring the manifold portion comprise:
calculating the size of the outer catalytic body and selecting the most suitable new support;
welding the new support, containing the catalytic structure, to the original part;
painting at high temperature;
said process is applied to the cases when:
on the outside there is a single body and on the inside there is a catalyst (1) and a particulate filter (2); or there is a need for
retrofitting the catalyst and the particulate filter on vehicles without the original particulate filter.

8. Process according to claim 1 wherein, according to an additional embodiment, the removal steps of the spent catalyst from the exhaust manifolds consists in the removal of the spent block;
and wherein the steps of inserting the new component and restoring the manifold portion consists in the insertion of the new particulate filter or a new catalytic body, including the welding to the end of the support, a flange (9) of the same size as the original one of the particulate filter;
said process is applied to the cases when there is a particulate filter or a catalyst with a single and independent structure (8).

9. Process according to claim 1 wherein, the procedure to add a particulate filter to the initial catalyst structure, comprises the steps of:
sectioning in point A, as indicated by FIG. 20;
inserting a particulate filter with the same external diameter as the catalyst;
reassembling all the pieces through welding;
resizing the piece, making a cut in point B, as indicated by FIG. 21;
abrasive blasting and painting.
